(19) United States
(12) Patent Application Publication
(10) Pub. No.: US 2015/0281185 A1
(43) Pub. Date: Oct. 1, 2015

(54) Cloud Collaboration System With External Cryptographic Key Management

(71) Applicant: Cisco Technology, Inc., San Jose, CA (US)

(72) Inventor: Shaun Cooley, El Segundo, CA (US)

(73) Assignee: Cisco Technology, Inc., San Jose, CA (US)

(21) Appl. No.: 14/225,644

(22) Filed: Mar. 26, 2014

(51) Int. Cl. H04L 29/06; G06F 17/30

(52) U.S. Cl. CPC H04L 63/0428; H04L 63/061; G06F 17/30864

(57) ABSTRACT

The embodiments presented herein provide for a method for a key management service (KMS) to provide a conversation key over individually established secure channels. The KMS establishes, with a first device, a first ephemerally secure communication channel over an unsecure network. The KMS receives, over the first ephemerally secure communication channel, a first request for a conversation key. After obtaining the conversation key, the KMS transmits the conversation key to the first device over the first ephemerally secure communication channel. The KMS establishes, with a second device, a second ephemerally secure communication channel over the unsecure network. The KMS receives, over the second ephemerally secure communication channel, a second request for the conversation key. The conversation key is transmitted to the second device over the second ephemerally secure communication channel.

### TECHNICAL FIELD

The present disclosure relates to providing a secure cloud based collaboration system.

### BACKGROUND

Online collaboration systems allow participants from around the world to communicate and share ideas. To enable scalable solutions, a collaboration system may transition away from on-premise deployed infrastructure, signaling, and media control to cloud hosted services. However, customers may be hesitant to switch to cloud-hosted services due to perceived loss of control around security and privacy of the collaboration data. This perception may be exacerbated by the fact that collaboration products may carry highly confidential customer information in an easily digestible format (e.g., text, voice, video, electronic documents).

### BRIEF DESCRIPTION OF THE DRAWINGS

FIG. 1 is a block diagram of a system of devices configured to participate in an online collaboration session according to an example embodiment.

FIG. 2A is a block diagram of a key management server according to an example embodiment.

FIG. 2B is a block diagram of a client device configured to participate in the online collaboration session according to an example embodiment.

FIG. 3 is a block diagram of client devices setting up ephemerally secure channels with an on-premise key management service according to an example embodiment.

FIG. 4 is a block diagram of client devices securely receiving conversation keys from the on-premise key management service according to an example embodiment.

FIG. 5 is block diagram of client devices participating in a collaboration session according to an example embodiment.

FIG. 6 is a flowchart depicting operations of a key management server in distributing a conversation key according to an example embodiment.

FIG. 7 is a flowchart depicting operations of a client device in obtaining a conversation key for an encrypted conference session according to an example embodiment.

FIG. 8 is a flowchart depicting operations of a cloud hosted collaboration server in facilitating an encrypted collaboration session according to an example embodiment.

### DESCRIPTION OF EXAMPLE EMBODIMENTS

### Overview

The embodiments presented herein provide for a method for a key management service (KMS) to provide a conversation key over individually established secure channels. The KMS establishes, with a first device, a first ephemerally secure communication channel over an unsecure network. The KMS receives, over the first ephemerally secure communication channel, a first request for a conversation key. After obtaining the conversation key, the KMS transmits the conversation key to the first device over the first ephemerally secure communication channel. The KMS establishes, with a second device, a second ephemerally secure communication channel over the unsecure network. The KMS receives, over the second ephemerally secure communication channel, a second request for the conversation key. The conversation key is transmitted to the second device over the second ephemerally secure communication channel.

### Example Embodiments

With the inherently remote nature of cloud hosted services, customers may be concerned about the privacy and security of data, such as data generated by cloud-based collaboration services. One example of a solution to ensure privacy and security in a cloud-hosted collaboration system may be to give customers on-premise control of the cryptographic keys used in establishing secure end-to-end communication session between client devices. In this way, the customer can maintain control over the security and privacy of the communications, while allowing the cloud-hosted system to handle the large scale issues of distribution, high availability, message delivery, and archiving. Additionally, the cloud-based service may allow for search indexing of a collaboration session, also called a conversation hereinafter, maintaining a scalable search index encrypted in the cloud.

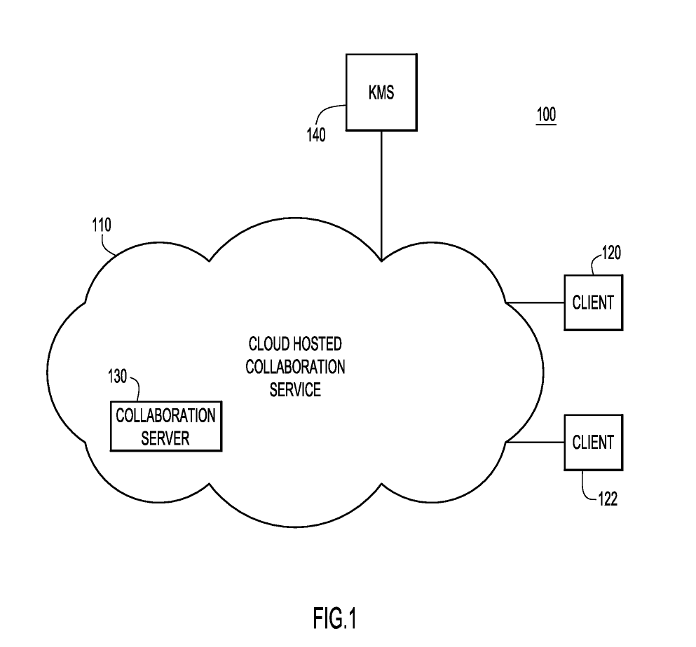

Referring to FIG. 1, an online conference system 100 is shown that enables a cloud-hosted collaboration service (CHCS) 110 to facilitate an online collaboration session (e.g., a web meeting, conversation, etc.) between client devices 120 and 122. Collaboration server 130 is provided to facilitate the conversation, and may comprise a plurality of servers as needed by the CHCS 110. Key Management Service (KMS) 140 provides authentication and cryptographic keys to clients 120 and 122. To address the customer control of data within the collaboration sessions, KMS 140 may be within a trust boundary, and is generally referred to as an on-premise asset. On-premise assets such as KMS 140 may comprise computing devices that are physically located under the control of the customer. The KMS 140 may be embodied as modules of the same server of other on-premise assets, or they may be on separate co-located servers. Additionally, the on-premise devices may be located at two different locations, as long as both locations and devices are physically under the control of the customer.

The online conference session may comprise voice, video, chat, desktop sharing, application sharing, and/or other types of data communication. Only two client devices are shown in FIG. 1, but any number of client devices may be included in system 100. Client devices 120 and 122 may take a variety of forms, including a desktop computer, laptop computer, mobile/cellular phone, tablet computer, Internet telephone, etc. CHCS 110 may be provided over any type of network (e.g., any combination of Internet, intranet, local area network (LAN), wide area network (WAN), wired network, wireless network, etc.) that connects computing devices, e.g., client devices 120 and 122, collaboration server 130, and KMS 140. CHCS 110 may be used, for example, to mediate transactions between client devices 120 and 122. CHCS 110 may also perform caching or other time/bandwidth saving techniques. It should be understood that in a web-based conference system, each device may communicate with the CHCS 110 through a browser application having one or more plug-ins that enable a web-based meeting, and allow for the transmission of data to the collaboration server 130, and the reception of data from the collaboration server 130 during a conversation.

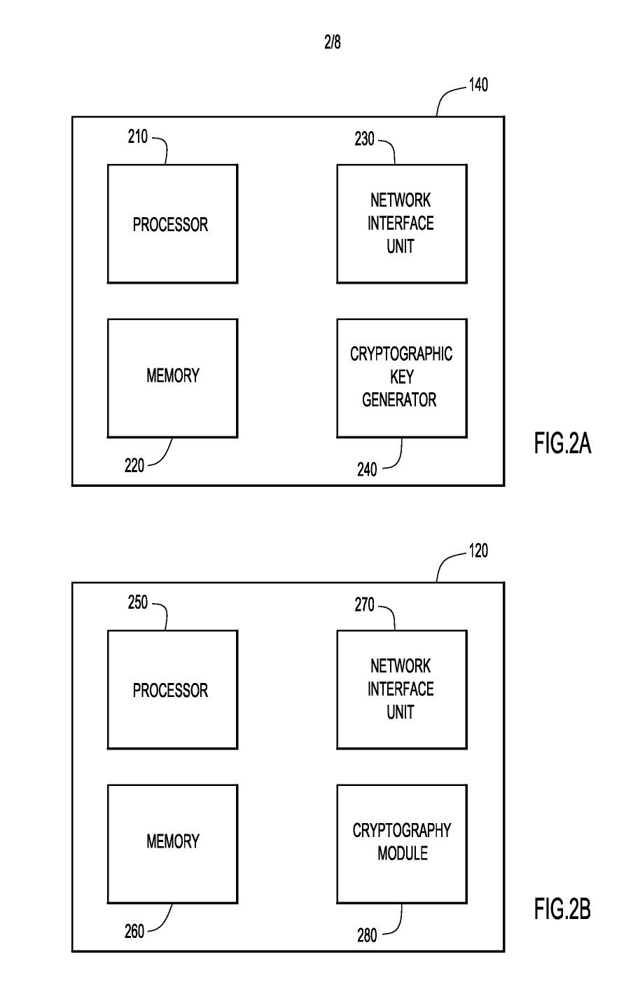

Referring now to FIG. 2A, a simplified block diagram of a KMS server 140 configured to provide a key management service is shown. Server 140 includes a processor 210 to process instructions relevant to an online collaboration session supported by the system 100, memory 220 to store a variety of data and software instructions (e.g., audio, video, control data, etc.). The server 140 also includes a network interface unit (e.g., card) 230 to communicate with CHCS 110 and client devices 120 and 122. Server 140 also includes cryptographic key generator 240 to generate cryptographic keys that may be used as conversation keys in an encrypted online collaboration session. Memory 220 may comprise read only memory (ROM), random access memory (RAM), magnetic disk storage media devices, optical storage media devices, flash memory devices, electrical, optical, or other physical/tangible (e.g., non-transitory) memory storage devices. The processor 210 is, for example, a microprocessor or microcontroller that executes instructions for implementing the processes described herein. Thus, in general, the memory 220 may comprise one or more tangible (non-transitory) computer readable storage media (e.g., a memory device) encoded with software comprising computer executable instructions and when the software is executed (by the processor 210) it is operable to perform the operations described herein.

Referring now to FIG. 2B, a simplified block diagram of a client device 120 configured to participate in an encrypted online conference session is shown. Device 120 includes a processor 250 to process instructions relevant to an online collaboration session supported by the system 100, memory 260 to store a variety of data and software instructions (e.g., audio, video, control data, etc.). The device 120 also includes a network interface unit (e.g., card) 270 to communicate with CHCS 110 over a network. Device 120 also includes cryptography module 280 that is configured to encrypt and/or decrypt messages with a cryptographic key. For example, cryptography module 280 may provide end-to-end encryption for a secure online conference session. Memory 260 may comprise read only memory (ROM), random access memory (RAM), magnetic disk storage media devices, optical storage media devices, flash memory devices, electrical, optical, or other physical/tangible (e.g., non-transitory) memory storage devices. The processor 250 is, for example, a microprocessor or microcontroller that executes instructions for implementing the processes described herein. Thus, in general, the memory 260 may comprise one or more tangible (non-transitory) computer readable storage media (e.g., a memory device) encoded with software comprising computer executable instructions and when the software is executed (by the processor 250) it is operable to perform the operations described herein.

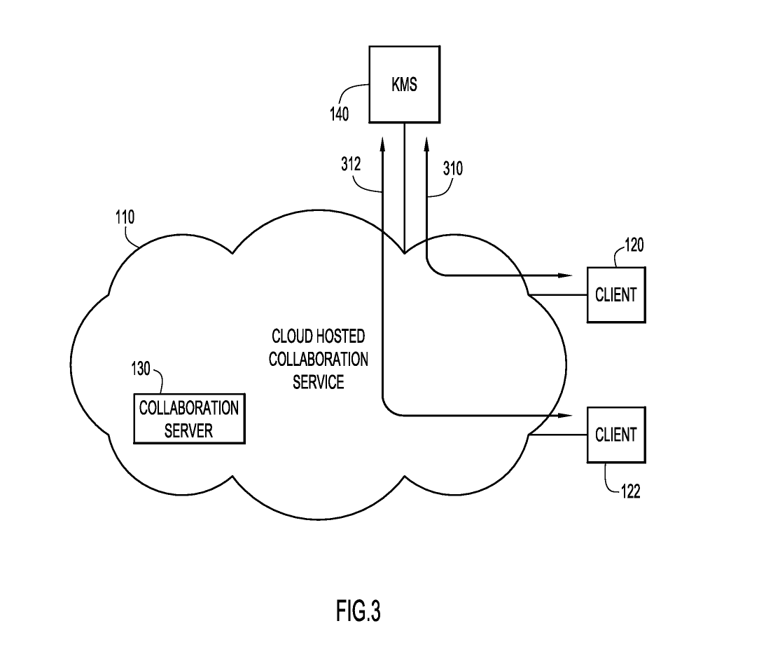

Referring now to FIG. 3, a simplified flow diagram of securing ephemerally secure channels is shown. In this exchange of messages, which may be a precursor to a collaboration session, clients 120 and 122 set up ephemerally secure communication channels 310 and 312, respectively. As used herein, “ephemeral” is taken to mean that the encryption (e.g., the cryptographic key) used for each ephemerally secure communication channel is only used temporarily (e.g., for a predetermined number of messages or for a predetermined, relatively short, period of time). For example, an ephemerally secure communication channel may be used to initiate a more robust encryption method by exchanging a key over the ephemerally secure channel.

In one example, the KMS 140 is responsible for generating, distributing, and maintaining records of all cryptographic keys issued to any clients within a single trust boundary, such as a corporation. In some examples, the trust boundary may be pushed out to the service provider level. In another example, the KMS 140 acts as a client to the CHCS 110, so that it is able to receive messages from and send messages to client devices 120 and 122. The KMS 140 may authenticate itself to client devices 120 and/or 122 by signing its messages using a public certificate that has been issued by a mutually trusted certificate authority. The client devices 120 and 122 are aware of KMS 140, and may display details of the key management system involved in a conversation to the user, such as the common name (CN) from the KMS's public certificate.

In one example, client device 120 will establish a secure communication channel with the KMS 140 when it starts up a collaboration session by performing a signed Diffie-Hellman ephemeral key exchange in which messages are relayed through the CHCS 110. Alternatively, an ephemerally secure channel may be created for each request in the conversation. The Diffie-Hellman exchange can be standard or elliptic curve based, or use any other method for securely exchanging a shared secret over an insecure communication channel. In order to prevent a man-in-the-middle attack, the signing of these exchange messages may include encrypting and signing all client-to-KMS messages with the public key of the KMS 140 and encrypting and signing all KMS-to-client messages with the private key of the KMS 140. Once the ephemerally secure messaging channels 310 and 312 are established, clients 120 and 122 may each use their respective channel for subsequent requests. Each request may include an authorization token that can be validated by the KMS 140, and which is different from any authorization tokens used for communications with the CHCS 110 in order to prevent the CHCS 110 from being able to replay authorization tokens to the KMS 140 and retrieve cryptographic keys.

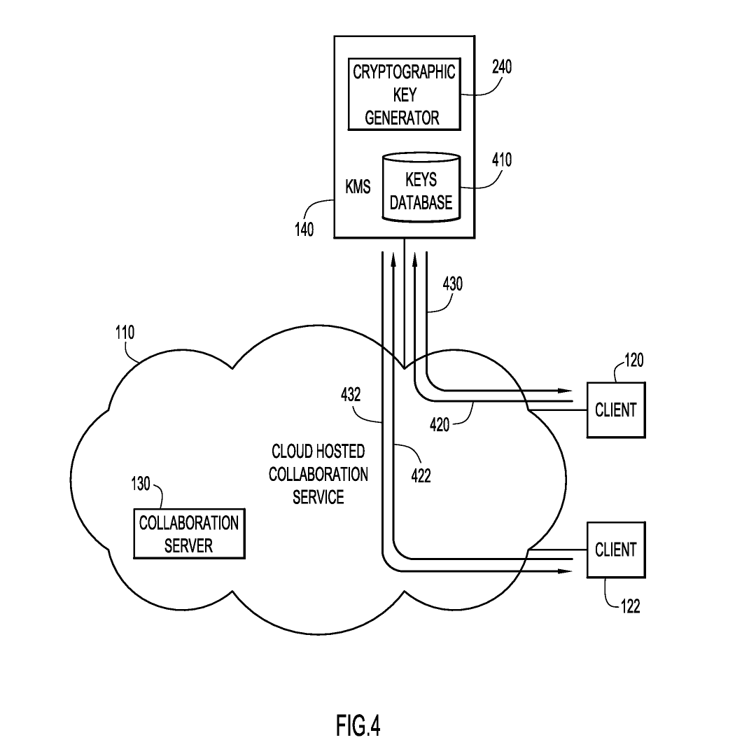

Referring now to FIG. 4, a simplified flow diagram of client devices securing conversation keys for a collaboration session is shown. KMS 140 may include a database 410 of cryptographic keys that are used as conversation keys. Alternatively, KMS 140 may use cryptographic key generator 240 to generate cryptographic keys for use as conversation keys. After establishing ephemerally secure channels as shown in FIG. 3, clients 120 and 122 send requests 420 and 422, respectively, for a conversation key. KMS server 140 retrieves or generates a cryptographic key for clients 120 and 122 to use as a conversation key, and sends the conversation key back in messages 430 and 432, respectively. In securing a conversation key from KMS 140, client devices 120 and 122 are not required to communicate with each other, and are not required to authenticate any device other than KMS 140. In other words, the only communication between client device 120 and client device 122 is encrypted using the conversation key provided individually to each client device 120 and 122 through separate ephemerally secure communication channels.

In one example, when client device 120 starts a collaboration session with an invitation to client 122, it notifies CHCS 110 of the invitation that is going to be sent. The CHCS 110 notifies the KMS 140, which generates a cryptographic key, associates it with the soon-to-be-established CHCS conversation, stores a copy of the key for subsequent use along with a list of authorized participants, and relays the conversation key through the ephemerally secured channels. According to one example, the conversation key is also associated with a conversation identifier. Once each client has received the conversation key, it can send symmetrically encrypted messages through the CHCS 110 to other conversation participants without concern that the message may be decrypted by the CHCS 110. Conversely, when client 122 receives the invitation to join a conversation, it sends a request 430 over its ephemerally secured CHCS channel to the KMS 140, along with its authorization token. Assuming the authorization token is valid for the requested conversation (i.e., client device 122 is an authorized participant), then the KMS 140 responds over the ephemerally secure channel with message 432 comprising the conversation key.

If a conversation member is added or removed after a conversation is established, the KMS 140 is notified of the change in participants. The KMS 140 can either add or revoke the authorization of the new or removed members in its database and rely on the CHCS to start or stop delivering messages to the new or removed members. Alternatively, the KMS 140 may generate a new conversation key, store the key and participant authorizations in its database, and distribute the new conversation key to the modified list of participants. Generating a new conversation key when a participant is removed from a conversation ensures that a malicious participant is unable to collude with the CHCS to continue to passively participate in a conversation after being removed.

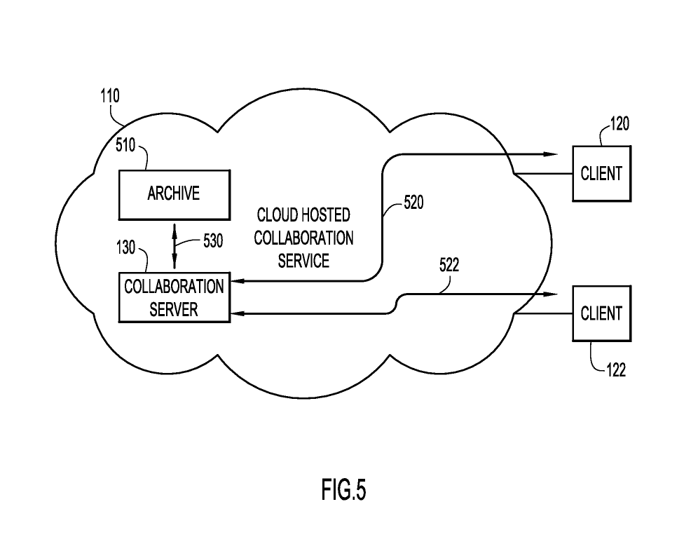

Referring now to FIG. 5, a simplified block diagram of a CHCS archiving a conversation is now described. In one example, CHCS 110 includes an archive 510 for storing messages in any conversation that is facilitated by collaboration server 130. In this example, client 120 exchanges messages 520 with collaboration server 130, and client 122 exchanges messages 522 with collaboration server 130. Through messages 520 and 522, clients 120 and 122 participate in a collaboration session. Collaboration server 130 sends copies 530 of the messages from the collaboration session to be stored in archive 510. In one example, the archived messages are associated with the corresponding conversation identifier. Within the CHCS 110, the archive 510 stores encrypted messages with no access to the data within the encrypted message. If a client has access to retrieve a message from archive 510, it would also need the appropriate authorizations to access the conversation key from the KMS 150 in order to decrypt the archived message.

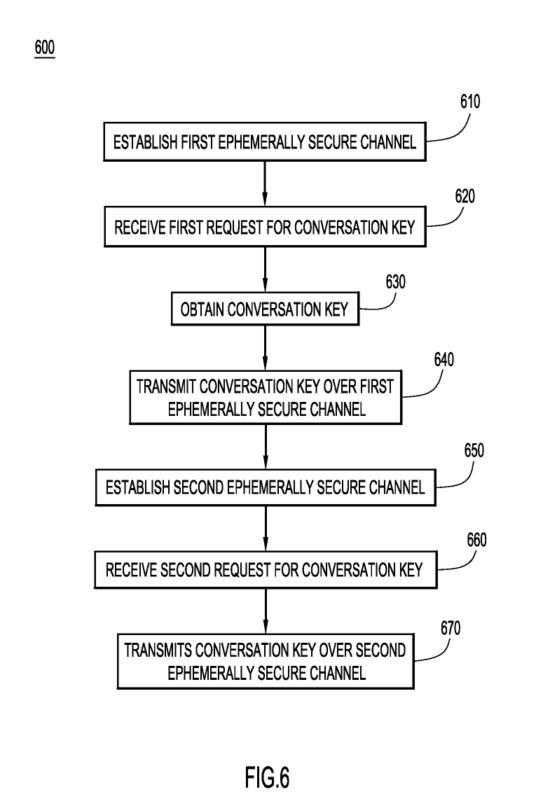

Referring now to FIG. 6, an example flowchart of a process 600 for distributing a conversation key to participants in an online conference session is now described. In step 610, the KMS establishes an ephemerally secure communication channel (e.g., through a Diffie-Hellman key exchange) with a first client device. The KMS receives a request for a conversation key over the first ephemerally secure communication channel at step 620. In step 630, the KMS obtains a conversation key, and transmits the conversation key back to the first device over the first ephemerally secure communication channel at step 640. A second client device establishes a second ephemerally secure communication channel with the KMS at step 650, and the KMS receives a second request for the conversation key at step 660. In step 670, the KMS transmits the conversation key to the second device over the second ephemerally secure communication channel. Additional client devices may also set up their own ephemerally secure communication channels and request the conversation key.

In one example, the requests for a conversation key comprise a conversation identifier. The KMS may maintain a record of authorized users for each conversation identifier. Additionally, the KMS may generate a new cryptographic key each when a request with a new conversation identifier is received, and subsequently store the newly generated conversation key associated with the conversation identifier in a keys database. When another client device requests the conversation key associated with a conversation identifier, the KMS may determine whether the new client device is an authorized participant. If the new device is authorized, then the KMS may retrieve the conversation key from the keys database and transmit the conversation key back to the new device.

In some examples, the timing of the steps in process 600 may be altered. For example, the KMS may wait for each client device to set up an ephemerally secure communication channel and submit a request before obtaining the conversation key. This may alleviate the need for the KMS to retrieve the conversation key from the keys database each time a request is received.

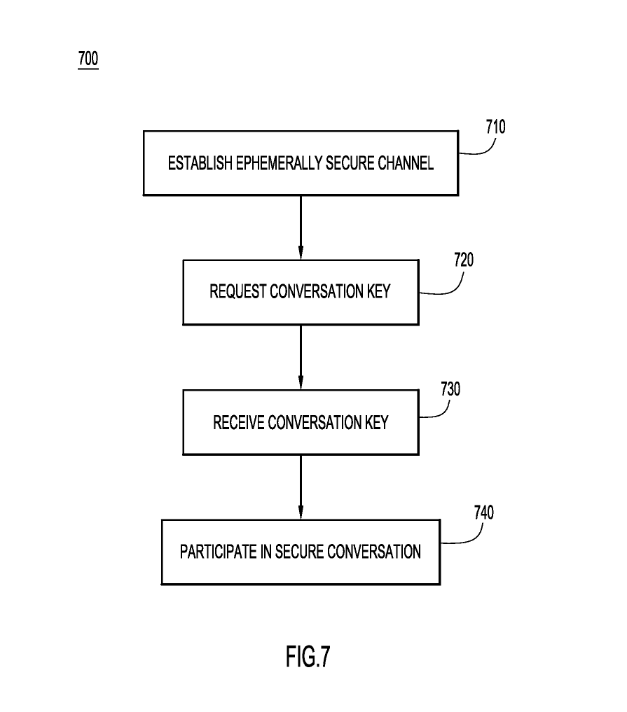

Referring now to FIG. 7, an example flowchart of a process 700 for obtaining a conversation key and participating in an end-to-end encrypted conversation is described. In step 710, a client device establishes an ephemerally secure communication channel with a key management service, and requests a conversation key at step 720. In one example, the request for a conversation key may comprise a conversation identifier. The client device receives the conversation key at step 730, and uses the conversation key to participate in a secure conversation at step 740.

In one example, participating in the secure conversation may comprise encrypting outgoing messages with the conversation key, and transmitting the encrypted outgoing messages to the other participants in the secure conversation. The client device may also receive encrypted incoming messages from the other participants, which may be decrypted with the conversation key. The decrypted incoming messages may be displayed or presented on the client device.

In another example, the encrypted incoming and outgoing messages may be mediated by the CHCS. The encrypted messages may be accompanied by an unencrypted conversation identifier, allowing the CHCS to route the encrypted messages to the appropriate client devices without having access to the encrypted content of the messages.

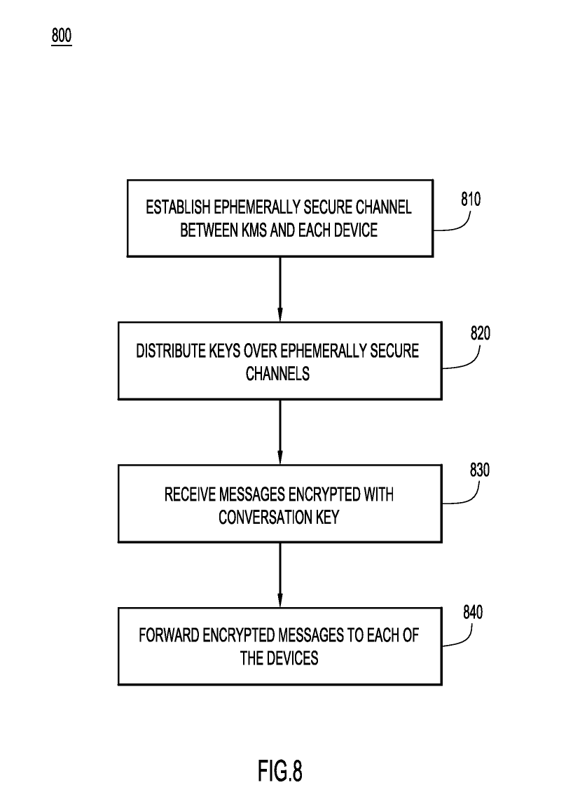

Referring now to FIG. 8, an example flowchart of a process 800 for facilitating a secure online conference session is described. In step 810, a KMS and a plurality of client devices secure ephemerally secure communication channels over a potentially unsecure connection (e.g., a cloud hosted collaboration service). Each device establishes an individual ephemerally secure communication channel with the KMS. The KMS distributes the conversation key to all of the client devices through their respective ephemerally secure communication channels at step 820. The transmission of the conversation key remains protected from the CHCS by the ephemerally secure communication channels. In step 830, the CHCS receives conversation messages encrypted with the conversation key, and forwards the encrypted messages to the client devices in the conversation at step 840. The content of the conversation remains protected from the CHCS by the encryption with the conversation key.

In summary, the techniques presented herein provide for hybrid cloud/on-premise end-to-end secure cloud hosted collaboration solution. This approach involves on-premise key management, while relying on the cloud for persistent storage and handling of message traffic. The end-to-end encryption maintains the confidentiality of the conversations, and the on-premise key management maintains the control over the encryption keys.

In one example, the techniques presented herein provide for a method for a key management service to provide a conversation key over individually established secure channels. The key management service establishes, with a first device, a first ephemerally secure communication channel over an unsecure network. The key management service receives, over the first ephemerally secure communication channel, a first request for a conversation key. After obtaining the conversation key, the key management service transmits the conversation key to the first device over the first ephemerally secure communication channel. The key management service establishes, with a second device, a second ephemerally secure communication channel over the unsecure network. The key management service receives, over the second ephemerally secure communication channel, a second request for the conversation key. The conversation key is transmitted to the second device over the second ephemerally secure communication channel.

In another example, the techniques presented herein provide for an apparatus configured to provide a conversation key over individually established secure channels. The apparatus comprises a network interface unit configured to enable communications with a first device and a second device over an insecure network. The apparatus also comprises a processor configured to establish, via the network interface unit, a first ephemerally secure communication channel with the first device. The processor is further configured to obtain, over the first ephemerally secure communication channel, a first request for a conversation key via the network interface unit. The processor is configured to obtain the conversation key and cause the conversation key to be transmitted via the network interface unit over the first ephemerally secure communication channel. The processor is further configured to establish, via the network interface unit, a second ephemerally secure communication channel with the second device. The processor is configured to obtain, over the second ephemerally secure communication channel, a second request for the conversation key received via the network interface unit. The processor is further configured to cause the conversation key to be transmitted via the network interface unit over the second ephemerally secure communication channel.

In a further example, the techniques presented herein provide for a method for a client device to participate in an end-to-end encrypted conversation. The client device establishes an ephemerally secure communication channel with a first device over an unsecure network, and requests a conversation key over the ephemerally secure communication channel. The client device receives the conversation key over the ephemerally secure communication channel. Using the conversation key, the client device participates in a secure conversation with a second device over the unsecure network.

In yet another example, the techniques presented herein provide for a method for a cloud hosted collaboration service (CHCS) to support an end-to-end encrypted conversation. The CHCS establishes a plurality of ephemerally secure communication channels between a key management server and a plurality of devices. Each of the plurality of ephemerally secure communication channels corresponds to only one of the plurality of devices. The CHCS distributes a conversation key obtained by the key management server to the plurality of devices over the plurality of ephemerally secure communication channels. The CHCS receives a plurality of encrypted conversation messages from the plurality of devices, and forwards the plurality of encrypted messages to the plurality of devices. The CHCS forwards the plurality of encrypted messages such that each of the plurality of devices obtains each of the plurality of encrypted messages.

The above description is intended by way of example only. Various modifications and structural changes may be made therein without departing from the scope of the concepts described herein and within the scope and range of equivalents of the claims.

What is claimed is:

1. A method comprising:
establishing, with a first device, a first ephemerally secure communication channel over an unsecure network;
receiving, over the first ephemerally secure communication channel, a first request for a conversation key;
obtaining the conversation key;
transmitting the conversation key to the first device over the first ephemerally secure communication channel;
establishing, with a second device, a second ephemerally secure communication channel over the unsecure network;
receiving, over the second ephemerally secure communication channel, a second request for the conversation key; and
transmitting the conversation key to the second device over the second ephemerally secure communication channel.

2. The method of claim 1, wherein obtaining the conversation key comprises generating a cryptographic key to be used as the conversation key.

3. The method of claim 1, wherein the first request for the conversation key and the second request for the conversation key each comprise a conversation identifier, and wherein the conversation identifier is the same in both the first request and the second request.

4. The method of claim 1, wherein obtaining the conversation key comprises receiving a cryptographic key to be used as the conversation key from a key database.

5. The method of claim 4, wherein the first request for the conversation key and the second request for the conversation key each comprise a conversation identifier, and wherein obtaining the conversation key further comprises:
requesting, from the key database, a cryptographic key associated with the conversation identifier; and
receiving from the key database, the cryptographic key to be used as the conversation key.

6. The method of claim 1, wherein establishing the first ephemerally secure communication channel and establishing the second ephemerally secure communication channel comprise engaging in a first Diffie-Hellman key exchange with the first device and engaging in a second Diffie-Hellman key exchange with the second device, respectively.

7. An apparatus comprising:
a network interface unit configured to enable communications with a first device and a second device over an unsecure network; and
a processor configured to:
establish, via the network interface unit, a first ephemerally secure communication channel with the first device;
obtain, over the first ephemerally secure communication channel, a first request for a conversation key received via the network interface unit;
obtain the conversation key;
cause the conversation key to be transmitted via the network interface unit over the first ephemerally secure communication channel;
establish, via the network interface unit, a second ephemerally secure communication channel with the second device;
obtain, over the second ephemerally secure communication channel, a second request for the conversation key received via the network interface unit;
cause conversation key to be transmitted via the network interface unit over the second ephemerally secure communication channel;

8. The apparatus of claim 7, wherein the processor is configured to obtain the conversation key by generating a cryptographic key to be used as the conversation key.

9. The apparatus of claim 7, wherein the first request for the conversation key and the second request for the conversation key each comprise a conversation identifier, and wherein the conversation identifier is the same in both the first request and the second request.

10. The apparatus of claim 7, wherein the processor is configured to obtain the conversation key by obtaining a cryptographic key to be used as the conversation key from a key database.

11. The apparatus of claim 10, wherein the first request for the conversation key and the second request for the conversation key each comprise a conversation identifier, and wherein the processor is configured to obtain the conversation key by:
requesting, from the key database, a cryptographic key associated with the conversation identifier; and
receiving from the key database, the cryptographic key to be used as the conversation key.

12. The apparatus of claim 7, wherein the processor is configured to establish the first ephemerally secure communication channel and the second ephemerally secure communication channel by engaging in a first Diffie-Hellman key exchange with the first device and engaging in a second Diffie-Hellman key exchange with the second device, respectively.

13. A method comprising:
establishing an ephemerally secure communication channel with a first device over an unsecure network;
requesting a conversation key over the ephemerally secure communication channel;
receiving the conversation key from the first device over the ephemerally secure communication channel; and
participating in a secure conversation with a second device over the unsecure network using the conversation key.

14. The method of claim 13, wherein establishing the ephemerally secure communication channel comprises engaging in a Diffie-Hellman key exchange with the first device.

15. The method of claim 13, wherein requesting the conversation key comprises transmitting a conversation identifier.

16. The method of claim 13, wherein participating in the secure conversation further comprises:
encrypting an outgoing message with the conversation key to generate an encrypted outgoing message;
transmitting the encrypted outgoing message to the second device over the unsecure network;
receiving an encrypted incoming message from the second device over the unsecure network;
decrypting the encrypted incoming message with the conversation key to generate an incoming message; and
presenting the incoming message.

17. The method of claim 16, further comprising transmitting an unencrypted conversation identifier with the encrypted outgoing message.

18. A method comprising:
establishing a plurality of ephemerally secure communication channels between a key management server and a plurality of devices, each of the plurality of ephemerally secure communication channels corresponding to only one of the plurality of devices;
distributing a conversation key obtained by the key management server to the plurality of devices over the plurality of ephemerally secure channels;
receiving a plurality of encrypted conversation messages from the plurality of devices; and
forwarding the plurality of encrypted messages to plurality of devices, such that each of the plurality of devices obtains each of the plurality of encrypted messages.

19. The method of claim 18, further comprising archiving the plurality of encrypted messages.

20. The method of claim 18, wherein establishing the plurality of ephemerally secure channels comprises hosting a Diffie-Hellman key exchange between the key management server and each of the plurality of electronic devices.

21. The method of claim 18, wherein each of the plurality of encrypted messages further comprises an unencrypted conversation identifier.
